(19) United States
(12) Patent Application Publication
(10) Pub. No.: US 2023/0349388 A1
(43) Pub. Date: Nov. 2, 2023

(54) IMPELLER, CENTRIFUGAL COMPRESSOR, AND METHOD FOR MANUFACTURING IMPELLER

(71) Applicant: IHI Corporation, Tokyo (JP)

(72) Inventors: Takashi FUJIWARA, Tokyo (JP); Taichi KIMURA, Tokyo (JP)

(73) Assignee: IHI Corporation, Tokyo (JP)

(21) Appl. No.: 18/349,228

(22) Filed: Jul. 10, 2023

Related U.S. Application Data
(63) Continuation of application No. PCT/JP2022/001768, filed on Jan. 19, 2022.

(30) Foreign Application Priority Data
Apr. 22, 2021 (JP) 2021-072886

(51) Int. Cl. F04D 29/28; F04D 17/10

(52) U.S. Cl. CPC F04D 29/284; F04D 17/10

(57) ABSTRACT

A compressor impeller includes: a hub provided at one end of a shaft; a blade arranged around an outer circumference of the hub; a leading edge formed on the blade and having a nonlinear shape different from a straight line connecting a shroud side end and a hub side end; and a blade surface formed between the leading edge and a trailing edge of the blade and having a curved-surface shape drawn by a trajectory of a movement of a generating line that is a straight line connecting the shroud side end and the hub side end.

### CROSS REFERENCE TO RELATED APPLICATIONS

This application is a continuation application of International Application No. PCT/JP2022/001768, filed on Jan. 19, 2022, which claims priority to Japanese Patent Application No. 2021-072886 filed on Apr. 22, 2021, the entire contents of which are incorporated herein by reference.

### BACKGROUND ART

### Technical Field

The present disclosure relates to an impeller, a centrifugal compressor, and a method for manufacturing the impeller.

Patent Literature 1 discloses a compressor impeller in which a hub and a plurality of blades arranged around the hub are integrally molded.

### CITATION LIST

### Patent Literature

Patent Literature 1: JP 2007-50444 A

### SUMMARY

### Technical Problem

Generally, a shape of a blade surface of a compressor impeller is widely machined at once by flank milling with aligning a rotational axis direction of a tool such as an end mill with a direction of a generating line. Since machining widely with using a flank of a tool, a machining time can be relatively shortened. However, a shape of a leading edge of the compressor impeller machined in such a way is formed straight in a span direction. When the leading edge is formed straight in the span direction, it is difficult to curb a flow reduction due to a collision at the leading edge.

The purpose of the present disclosure is to provide an impeller, a centrifugal compressor, and a method for manufacturing the impeller that can curb a flow reduction due to a collision at the leading edge while reducing machining time.

### Solution to Problem

To solve the above problem, an impeller according to the present disclosure includes: a hub provided at one end of a shaft; a blade arranged around an outer circumference of the hub; a leading edge formed on the blade and having a nonlinear shape different from a straight line connecting a shroud side end and a hub side end; and a blade surface formed between the leading edge and a trailing edge of the blade and having a curved-surface shape drawn by a trajectory of a movement of a generating line that is a straight line connecting the shroud side end and the hub side end.

A plurality of recesses adjacent to each other along a span direction may be formed on the leading edge.

To solve the above problem, a centrifugal compressor according to the present disclosure includes the above impeller.

To solve the above problem, a method for manufacturing an impeller according to the present disclosure includes: machining a blade surface between a leading edge and a trailing edge of a blade of an impeller by flank milling; and machining the leading edge by point milling.

### Effects of Disclosure

According to the present disclosure, a flow reduction due to a collision at the leading edge can be curbed while reducing machining time.

### BRIEF DESCRIPTION OF DRAWINGS

FIG. 1 is a schematic cross-sectional view of a turbocharger.

FIG. 2 is a perspective view of the compressor impeller.

FIG. 3 is an illustration of a shape of a blade.

FIG. 4 is an external view of a machine tool for the compressor impeller.

FIG. 5 illustrates the machine tool machining a material of the compressor impeller.

FIG. 6 is a first illustration of a machining process for the compressor impeller.

FIG. 7 is a second illustration of the machining process for the compressor impeller.

FIG. 8 is a third illustration of the machining process for the compressor impeller.

FIG. 9 is a fourth illustration of the machining process for the compressor impeller.

FIG. 10 is a flowchart illustrating a machining method (manufacturing method) of the compressor impeller.

FIG. 11 is a partially enlarged view of a leading edge of the blade according to the present embodiment.

FIG. 12 is an illustration of a shape of the leading edge according to the present embodiment.

### DESCRIPTION OF EMBODIMENTS

An Embodiment of the present disclosure will be described in detail below with reference to the accompanying drawings. Specific dimensions, materials, and numerical values described in the embodiments are merely examples for a better understanding, and do not limit the present disclosure unless otherwise specified. In this specification and the drawings, duplicate explanations are omitted for elements having substantially the same functions and configurations by assigning the same sign. Furthermore, elements not directly related to the present disclosure are omitted from the figures.

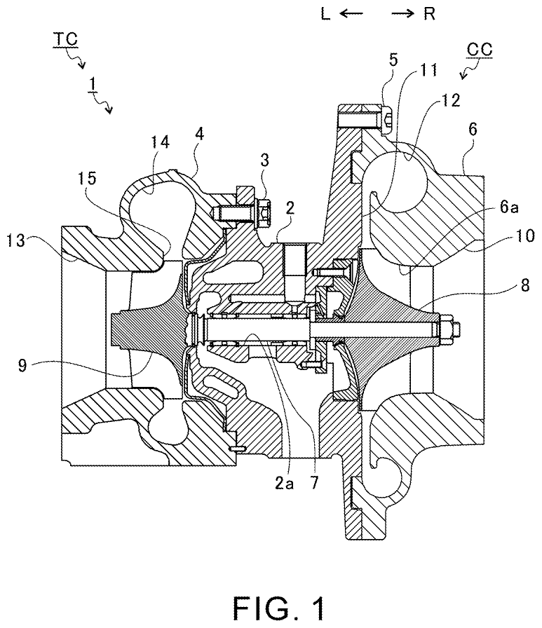

FIG. 1 is a schematic cross-sectional view of a turbocharger TC. Hereinafter, a direction indicated by an arrow L shown in FIG. 1 is described as a left side of the turbocharger TC. A direction indicated by an arrow R shown in FIG. 1 is described as a right side of the turbocharger TC. As shown in FIG. 1, the turbocharger TC comprises a turbocharger body 1. The turbocharger body 1 includes a bearing housing 2, a turbine housing 4, and a compressor housing 6. The turbine housing 4 is connected to the left side of the bearing housing 2 by fastening bolts 3. The compressor housing 6 is connected to the right side of the bearing housing 2 by fastening bolts 5.

A bearing hole 2a is formed in the bearing housing 2. The bearing hole 2a passes through the bearing housing 2 in the left-to-right direction of the turbocharger TC. A bearing is arranged in the bearing hole 2a. In the present embodiment, the bearing is a full floating bearing. However, the bearing may be other bearings such as a semi-floating bearing or a rolling bearing. A shaft 7 is rotatably supported by the bearing. A compressor impeller 8 (impeller) is provided at the right end of the shaft 7. The compressor impeller 8 is rotatably housed in the compressor housing 6. A turbine wheel 9 is provided at the left end of shaft 7. The turbine wheel 9 is rotatably housed in the turbine housing 4. In the present disclosure, an “axial direction,” a “radial direction,” and a “circumferential direction” of the shaft 7, the compressor impeller 8, and turbine wheel 9 may simply be referred to as the “axial direction,” the “radial direction,” and the “circumferential direction,” respectively.

An inlet 10 is formed in the compressor housing 6. The inlet 10 opens to the right side of the turbocharger TC. The inlet 10 is connected to an air cleaner (not shown). A diffuser flow path 11 is formed by surfaces of the bearing housing 2 and the compressor housing 6. The diffuser flow path 11 pressurizes air. The diffuser flow path 11 is formed in an annular shape. The diffuser flow path 11 is connected to the inlet 10 via the compressor impeller 8 at a radially inner area. Among inner surfaces of the compressor housing 6, a surface radially facing the compressor impeller 8 is formed as a shroud surface 6a.

A compressor scroll flow path 12 is formed in the compressor housing 6. For example, the compressor scroll flow path 12 is located radially outside the diffuser flow path 11. The compressor scroll flow path 12 is connected to an intake port of an engine (not shown) and the diffuser flow path 11. When the compressor impeller 8 rotates, air is sucked into the compressor housing 6 from the inlet 10. The sucked air is pressurized and accelerated when passing through blades of the compressor impeller 8. The pressurized and accelerated air is further pressurized in the diffuser flow path 11 and the compressor scroll flow path 12. The pressurized air is directed to the intake port of the engine.

A centrifugal compressor CC comprises the compressor housing 6 and the bearing housing 2. In the present embodiment, an example of the centrifugal compressor CC mounted in the turbocharger TC is described. However, the centrifugal compressor CC is not limited thereto, and may be incorporated in a device other than the turbocharger TC, or may be a stand-alone unit.

An outlet 13 is formed in the turbine housing 4. The outlet 13 opens to the left side of the turbocharger TC. The outlet 13 is connected to an exhaust gas purifier (not shown). A turbine scroll flow path 14 and a connecting passage 15 are formed in the turbine housing 4. For example, the turbine scroll flow path 14 is located radially outside the connecting passage 15. The turbine scroll flow path 14 is connected to a gas inlet (not shown). Exhaust gas discharged from an engine exhaust manifold (not shown) is directed to the gas inlet. The connecting passage 15 connects the turbine scroll flow path 14 to the outlet 13 via the turbine wheel 9. The exhaust gas led from the gas inlet to the turbine scroll flow path 14 is further led to the outlet 13 via the connecting passage 15 and the turbine wheel 9. The exhaust gas led to the outlet 13 rotates the turbine wheel 9 while passing therethrough.

The rotational force of the turbine wheel 9 is transmitted to the compressor impeller 8 via the shaft 7. As the compressor impeller 8 rotates, air is pressurized as described above. As such, the air is directed to the intake port of the engine.

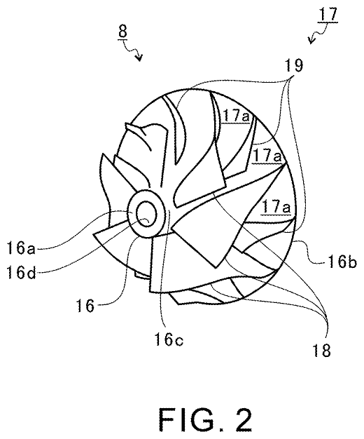

FIG. 2 is a perspective view of the compressor impeller 8. As shown in FIG. 2, the compressor impeller 8 includes a hub 16 (wheel) and a plurality of blades 17.

The Hub 16 includes a top surface 16a, a bottom surface 16b, an outer circumferential surface 16c, and a through hole 16d. An area of the top surface 16a is smaller than that of the bottom surface 16b. The outer circumferential surface 16c is connected to the top surface 16a and the bottom surface 16b, and extends radially outward from the top surface 16a to the bottom surface 16b.

The through hole 16d passes through from the top surface 16a to the bottom surface 16b. The shaft 7 is inserted into the through hole 16d. An end of the shaft 7 protrudes from the top surface 16a. A threaded groove is formed on the end of the shaft 7 protruding from the top surface 16a. By fastening a nut to this threaded groove, the hub 16 is provided at one end of the shaft 7. The hub 16 is a rotating body that rotates around the center of the through hole 16d as its rotational axis.

The blade 17 is a thin plate-shaped member integrally molded with the hub 16. A plurality of blades 17 are arranged on the outer circumferential surface 16c of the hub 16 with being spaced apart from each other in the circumferential direction. A circumferential gap between adjacent blades 17 (a blade gap 17a) serves as a flow path of air (fluid). The blades 17 extend radially outward from the outer circumferential surface 16c of the hub 16 toward the shroud surface 6a (see FIG. 1), and are curved so as to be inclined in the circumferential direction.

The blades 17 include full blades 18 (long blades), and splitter blades 19 (short blades) each of which has an axial length shorter than that of the full blade 18. The full blades 18 and the splitter blades 19 are arranged alternately in the circumferential direction. This configuration of splitter blades 19 between full blades 18 allows the turbocharger TC to improve air suction efficiency compared to a configuration with the same number of blades 17 all consisting of full blades 18. Hereafter, when simply referring to the blade 17, both the full blade 18 and the splitter blade 19 are indicated.

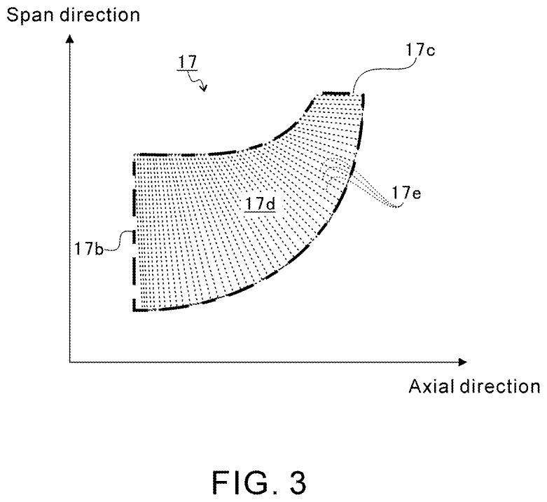

FIG. 3 is an illustration of a shape of the blade 17. In FIG. 3, a meridional shape of the blade 17 according to the present embodiment is shown in dashed-dotted lines. The meridional shape is a projection of the contour of a single blade 17 rotated around the rotational axis of the hub 16 without changing the radial position of the hub 16 onto a plane parallel to the rotational axis of the hub 16. In FIG. 3, the left-to-right direction corresponds to the axial direction of the shaft 7, with the right side being a side of the bottom surface 16b of the hub 16 and the left side being a side of the top surface 16a of the hub 16. In FIG. 3, the vertical direction is a span direction (blade length direction) of the blade 17, with the upper side being a side of the shroud surface 6a (hereinafter simply referred to as a shroud side) and the lower side being a side of the outer circumference surface 16c of the hub 16 (hereinafter simply referred to as a hub side).

As shown in FIG. 3, the blade 17 has a leading edge 17b that is an upstream end in a flow direction of air passing through the compressor impeller 8 (hereinafter simply referred to as the flow direction). Note that, in the flow direction, the leading edge 17b that is one end of the splitter blade 19 in the axial direction is located downstream of the leading edge 17b that is one end the full blade 18 in the axial direction.

The blade 17 has a trailing edge 17c that is a downstream end in the flow direction. A blade surface 17d is a curved surface formed between the leading edge 17b and the trailing edge 17c of the blade 17 and facing the flow path formed in the blade gap 17a.

As shown in FIG. 3, in the meridional shape, the leading edge 17b is substantially parallel to the radial direction. The trailing edge 17c is substantially parallel to the axial direction.

The blade surface 17d includes the leading edge 17b and the trailing edge 17c as the ends, and has a curved-surface shape (ruled surface) drawn by a trajectory of a continuous movement of a straight generating line 17e of the blade 17 (shown as a dashed line in FIG. 3). In other words, with respect to the ruled surface drawn by a trajectory of a movement of a straight line (line segment) connecting a shroud side end and a hub side end, the generating line 17e is a straight line at one of positions in the trajectory of the movement of the straight line. As such, the compressor impeller 8 is configured as a so-called ruled surface impeller. Hereinafter, a machine tool for the compressor impeller 8 will be described, and then a manufacturing method (processing method) of the compressor impeller 8 will be described.

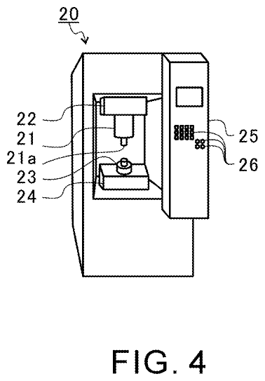

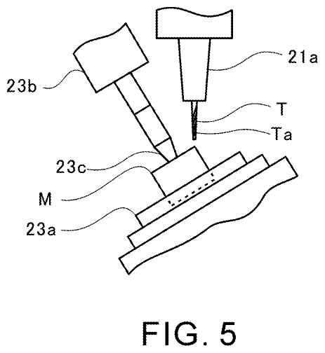

FIG. 4 is an external view of a machine tool 20 for the compressor impeller 8. FIG. 5 illustrates the machine tool 20 machining a material M of the compressor impeller 8.

For example, the machine tool 20 is configured as a simultaneous 5-axis machining center. As shown in FIG. 4, the machine tool 20 comprises a rotating unit 21, a moving unit 22, a holding unit 23, a moving unit 24, a control unit 25, and an operation unit 26. As shown in FIG. 5, the rotating unit 21 includes a chuck 21a that supports a tool T such as an end mill, and a motor (not shown). With the chuck 21a supporting the tool T, the motor power rotates the chuck 21a with the tool T. The chuck 21a supports the tool T with a rotational axis of the chuck 21a being aligned with the axial center of the tool T.

For example, the moving unit 22 includes an automated stage that can be moved in three mutually orthogonal axes by motors (not shown). The moving unit 22 supports the rotating unit 21 and can move the rotating unit 21 in any of the three axes.

For example, the holding unit 23 includes a clamping device. The holding unit 23 holds the material M of the compressor impeller 8. A hole that is to be the through hole 16d of the hub 16 is formed in the material M in advance. The holding unit 23 includes a first clamp 23a that holds the outer circumference surface of the material M. A second clamp 23b is arranged opposite to the first clamp 23a across the material M. A pin 23c is fixed to the second clamp 23b. The pin 23c has a tapered shape with a smaller diameter at the tip. The tip of the pin 23c is inserted into the hole in the material M that is to be the through hole 16d of the hub 16. The material M is clamped by the first clamp 23a and the pin 23c.

The moving unit 24 supports the holding unit 23. For example, the moving unit 24 may revolve the holding unit 23 with the material M around two axes different from each other by motors (not shown).

Relative positions and orientations of the tool T and the material M can be changed with a high degree of freedom by the cooperation of the moving units 22 and 24.

The control unit 25 controls the rotation of the tool T by the rotating unit 21 and the relative positions and orientations of the tool T and the material M by the moving units 22 and 24 in according with a machining path and other information input through the operation unit 26. The following is a detailed description of a flow of a machining process for the compressor impeller 8 by the control unit 25.

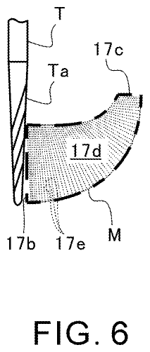

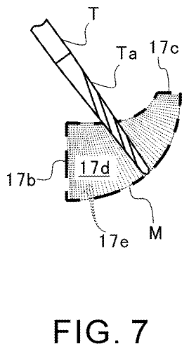

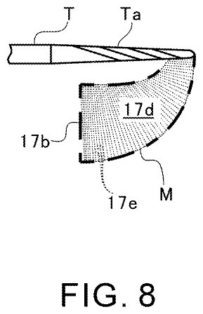

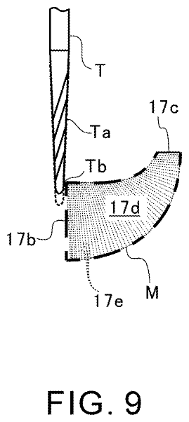

FIG. 6 is a first illustration of the machining process for the compressor impeller 8. FIG. 7 is a second illustration of the machining process for the compressor impeller 8. FIG. 8 is a third illustration of the machining process for the compressor impeller 8. FIG. 9 is a fourth illustration of the machining process for the compressor impeller 8. In FIGS. 6 to 9, the machine tool 20 is omitted for a better understanding.

In machining the ruled surface impeller, a rotational axis direction of the tool T is aligned with a direction of the generating line 17e, and a flank Ta of the tool T is used to cut the material M of the compressor impeller 8.

The control unit 25 controls the moving units 22 and 24 and the rotating unit 21 to cut the material M by the flank Ta of the tool T, aligning the rotational axis of the tool T with the direction of the generating line 17e, as shown in FIGS. 6-8. In other words, the control unit 25 rotates the tool T and cuts the material M at areas that are to be the gaps between the plurality of blades 17 (blade gaps 17a) by the flank Ta from the leading edge 17b to the trailing edge 17c. In this situation, the control unit 25 continuously increases an inclination angle of the tool T in a direction in which the axis direction of the tool T approaches from the leading edge 17b to the trailing edge 17c. As such, the control unit 25 cuts the blade surface 17d between the leading edge 17b and the trailing edge 17c of the blade 17 by the flank Ta of the tool T.

After the blade surface 17d is cut, the rotational axis direction of the tool T is aligned with a direction (span direction of the leading edge 17b) that intersects the axial direction of the shaft 7, and a point Tb of the tool T is used to cut a portion of the material M corresponding to the leading edge 17b.

The control unit 25 controls the moving units 22 and 24 and the rotating unit 21 to rotate the tool T and cut the material M at the portion that is to be the leading edge 17b by the point Tb along a thickness direction of the blade 17 (blade thickness direction), as shown in FIG. 9. After cutting in the blade thickness direction, the control unit 25 moves the tool T to a position adjacent to the cut site in the span direction as shown by the dashed line in FIG. 9, and cuts the material M at a portion that is to be the leading edge 17b by the point Tb along the blade thickness direction again. Repeating this process, the control unit 25 moves the tool T from the shroud side end to the hub side end of the leading edge 17b to cut the material M. As such, the control unit 25 cuts the leading edge 17b by the point Tb of the tool T.

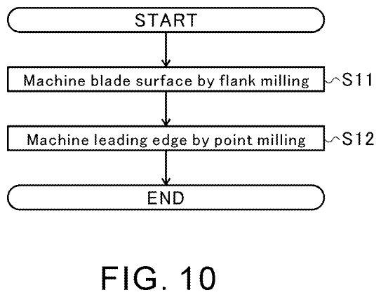

FIG. 10 is a flowchart illustrating the machining method (manufacturing method) of the compressor impeller 8. The flowchart shown in FIG. 10 is executed by the control unit 25 of the machine tool 20. First, the control unit 25 machines the blade surface 17d between the leading edge 17b and trailing edge 17c of the blade 17 by the flank Ta of the tool T (step S11), as shown in FIGS. 6-8. Next, the control unit 25 machines the leading edge 17b by the point Tb of the tool T, as shown in FIG. 9 (step S12). As such, the blade 17 of the compressor impeller 8 is formed. However, the order of machining is not limited thereto. For example, the blade surface 17d may be machined (step S11) after the leading edge 17b is machined (step S12).

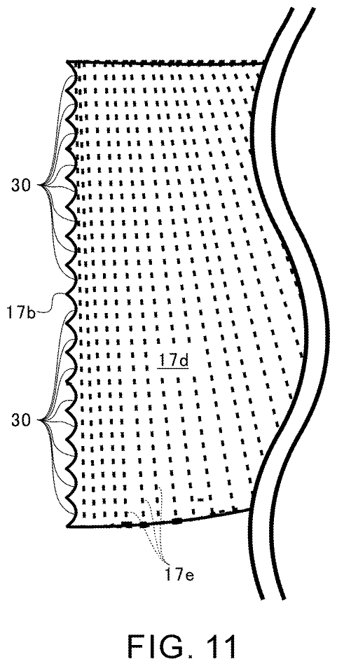

FIG. 11 is a partially enlarged view of the leading edge 17b of the blade 17 according to the present embodiment. As mentioned above, the leading edge 17b according to the present embodiment is cut by the point Tb of the tool T that moves along the thickness direction of the blade 17. As shown in FIG. 11, therefore, a plurality of recesses 30 adjacent and continuous to each other along the span direction are formed in the leading edge 17b. The plurality of recesses 30 are, for example, grooves extending in a direction intersecting (orthogonal to) the span direction of the leading edge 17b. The recess 30 has a shape depending on the shape of the point Tb of the tool T.

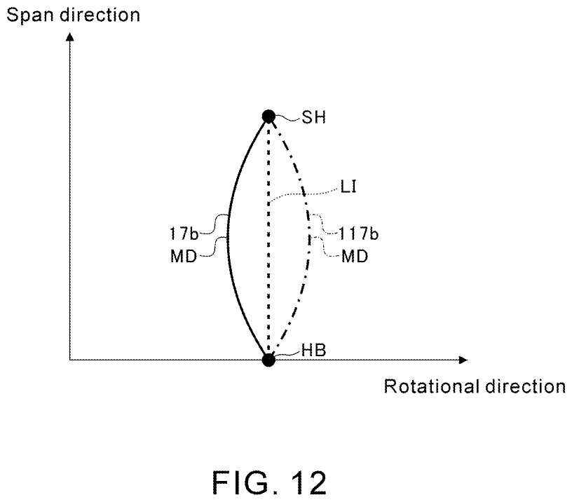

FIG. 12 is an illustration of the shape of the leading edge 17b according to the present embodiment. As shown in FIG. 12, the shape of the leading edge 17b according to the present embodiment has a nonlinear shape that is different from the straight line LI (dashed line in FIG. 11) connecting the shroud side end SH and the hub side end HB. The nonlinear shape includes, for example, a circular arc shape, an elliptical arc shape, a curved shape, etc.

The leading edge 17b has an intermediate portion MD between the shroud side end SH and the hub side end HB. In the present embodiment, the leading edge 17b has an arc shape where the intermediate portion MD is positioned backward in the rotational direction of the compressor impeller 8 relative to the shroud side end SH and the hub side end HB. Specifically, the center of the leading edge 17b in the span direction is located at the most backward position in the rotational direction relative to the shroud side end SH and the hub side end HB. As such, the leading edge 17b has an arc shape that protrudes backward in the rotational direction of the compressor impeller 8.

However, the blade 17 is not limited thereto, and may have a leading edge 117b, for example, as shown by a dashed-dotted line in FIG. 12. The leading edge 117b has an arc shape where the intermediate portion MD is located forward in the rotational direction of the compressor impeller 8 relative to the shroud side end SH and the hub side end HB. Specifically, the center of the leading edge 117b in the span direction is located at the most forward position in the rotational direction relative to the shroud side end SH and the hub side end HB. As such, the leading edge 117b has an arc shape that protrudes forward in the rotational direction of the compressor impeller 8.

As described above, the blade surface 17d of the blade 17 is machined by the flank Ta of the tool T. This reduces the machining time compared to the case where the blade surface 17d of the blade 17 is machined by the point Tb of the tool T.

Furthermore, the leading edge 17b and 117b of the blade 17 is machined by the point Tb of the tool T. Unlike the flank Ta, the point Tb of the tool T does not extend in a straight line. Therefore, by machining by the point Tb of the tool T, the leading edge 17b and 117b can be made into a nonlinear shape different from the straight line LI connecting the shroud side end SH and the hub side end HB. As a result, a flow reduction due to a collision at the leading edge 17b and 117b can be reduced.

Although the embodiment of the present disclosure has been described above with reference to the accompanying drawings, the present disclosure is not limited thereto. It is obvious that a person skilled in the art can conceive of various examples of variations or modifications within the scope of the claims, which are also understood to belong to the technical scope of the present disclosure.

The above embodiment describes an example in which the blade surface 17d is machined by the flank Ta of the tool T and the leading edge 17b is machined by the point Tb of the tool T. However, the present disclosure is not limited thereto, and in addition to the leading edge 17b, a portion of the blade surface 17d may be machined by the point Tb of the tool T. For example, an area closer to the leading edge 17b in the blade surface 17d may be machined by the point Tb of the tool T, and an area closer to the trailing edge 17c in the blade surface 17d may be machined by the flank Ta of the tool T.

What is claimed is:

1. An impeller comprising:
a hub provided at one end of a shaft;
a blade arranged around an outer circumference of the hub;
a leading edge formed on the blade and having a nonlinear shape different from a straight line connecting a shroud side end and a hub side end; and
a blade surface formed between the leading edge and a trailing edge of the blade and having a curved-surface shape drawn by a trajectory of a movement of a generating line that is a straight line connecting the shroud side end and the hub side end.

2. The impeller according to claim 1, wherein a plurality of recesses adjacent to each other along a span direction are formed on the leading edge.

3. A centrifugal compressor comprising an impeller according to claim 1.

4. A centrifugal compressor comprising an impeller according to claim 2.

5. A method for manufacturing an impeller, comprising:
machining a blade surface between a leading edge and a trailing edge of a blade of an impeller by flank milling; and
machining the leading edge by point milling.
